(19) United States
(12) Patent Application Publication
(10) Pub. No.: US 2021/0390226 A1
(43) Pub. Date: Dec. 16, 2021

(54) DATA PROCESSING APPARATUS, DATA PROCESSING SYSTEM, AND DATA PROCESSING METHOD

(71) Applicant: Hitachi, Ltd., Tokyo (JP)

(72) Inventors: Masanori ABE, Tokyo (JP); Osamu TOMOBE, Tokyo (JP)

(21) Appl. No.: 17/288,577

(22) PCT Filed: Aug. 20, 2019
(86) PCT No.: PCT/JP2019/032380

§ 371 Date: Apr. 26, 2021

(30) Foreign Application Priority Data
Nov. 26, 2018 (JP) 2018-220298

(51) Int. Cl. G06F 30/20; G06Q 30/02

(52) U.S. Cl. CPC G06F 30/20; H02J 3/00; G06Q 30/0201

(57) ABSTRACT

To improve coordination of processing that uses power demand data. A detail level determination unit 102 calculates, based on detail level format data D2, a detail level dataset D3 from a power demand dataset D1 generated by a power demand simulator 106. A data detail level conversion unit 103 calculates a converted power demand dataset D4 so that a detail level of the power demand dataset D1 matches a detail level required for a simulation in a power system simulator 105. A notification unit 104 displays a detail level conversion result indicated by the converted power demand dataset D4 and notifies the power system simulator 105 of the converted power demand dataset D4.

### TECHNICAL FIELD

The present invention relates to a data processing apparatus, a data processing system, and a data processing method, capable of coordinating processing that uses power demand data.

### BACKGROUND ART

With an increase in renewable energy, it is important to secure supply and demand adjustment capability to balance power supply and demand. In recent years, the supply and demand adjustment capability through output adjustment that has been carried out by large-scale thermal power plants decreases. Thus, as an alternative, demand adjustment capability, such as demand response, to adjust power supply and demand by increasing and decreasing power demand has been utilized. For regional energy management including heterogeneous systems (a transportation system of electric vehicles, an air conditioner system utilizing flows of people, etc.) as a supply source capable of providing the demand adjustment capability, it is important to quantitatively evaluate application effects of the demand adjustment capability. Techniques related to such simulation have presupposed that a data exchange format is defined in advance between simulators for conducting the simulation.

A technique related to monitoring control in the regional energy management is disclosed in PTL 1, for example. PTL 1 discloses “a control information apparatus, a control information system, and a control method, the control information apparatus being configured to receive monitoring data from an apparatus, calculate correction information for this monitoring data based on information of the external apparatus that has transmitted the monitoring data, add a calculation result to the monitoring data to obtain corrected data, extract the external apparatus to be controlled based on the corrected data, and transmit control information to the extracted external apparatus”. This technique disclosed in PTL 1 allows for the monitoring control by correcting data to suit known characteristics of the monitored object.

In order to make the best use of the demand adjustment capability in the regional energy management to formulate an operational plan, performing the integrated simulation of the systems is required. In order to extensively coordinate analysis results of the simulators for analysis, it is necessary to make time granularity, an adjustment capability type, a demand occurrence position, and the like consistent in the simulation.

### CITATION LIST

### Patent Literature

PTL 1: JP 2013-69084 A

### SUMMARY OF INVENTION

### Technical Problem

However, in the technique disclosed in PTL 1, when contents of the power demand data are inconsistent with information required by a power system simulator, the data fails to be corrected according to usage and the contents of the power demand data, resulting in failure to coordinate the simulators.

The present invention has been made in view of the above circumstances, and an object of the present invention is to provide a data processing apparatus, a data processing system, and a data processing method, capable of improving coordination of processing that uses power demand data.

### Solution to Problem

In order to achieve the above object, a data processing apparatus according to a first aspect includes a detail level determination unit configured to determine a detail level of power demand data based on a detail level format in which a detail level is defined based on a degree indicating how large an information amount of the power demand data is, and a detail level conversion unit configured to match the detail level of the power demand data determined by the determination unit to a required detail level of the power demand data.

### Advantageous Effects of Invention

According to the present invention, it is possible to improve coordination of processing that uses power demand data.

### BRIEF DESCRIPTION OF DRAWINGS

FIG. 1 is a block diagram showing a configuration of a data processing apparatus according to an embodiment.

FIG. 2 is a diagram showing an example of detail level format data of FIG. 1.

FIG. 3 is a block diagram showing an example of a hardware configuration of the data processing apparatus of FIG. 1.

FIG. 4 is a flowchart showing a detail level format conforming process of the data processing apparatus of FIG. 1.

FIG. 5 is a flowchart showing a detail level determination process of FIG. 4.

FIG. 6 is a flowchart showing a detail level conversion process of FIG. 4.

FIG. 7 is a diagram showing a display example of conversion conditions for a detail level dataset of FIG. 1.

FIG. 8 is a diagram showing an example of an input screen for a detail level supplement condition displayed on a display device of FIG. 3.

FIG. 9 is a diagram showing an example of a display screen for converted power demand data displayed on the display device of FIG. 3.

FIG. 10 is a diagram showing an example of a display screen for a detail level input format displayed on the display device of FIG. 3.

### DESCRIPTION OF EMBODIMENTS

An embodiment will be described with reference to the drawings. Note that the embodiment described below does not limit the invention according to the claims, and all of elements and combinations thereof described in the embodiment are not necessarily indispensable for the solution of the invention.

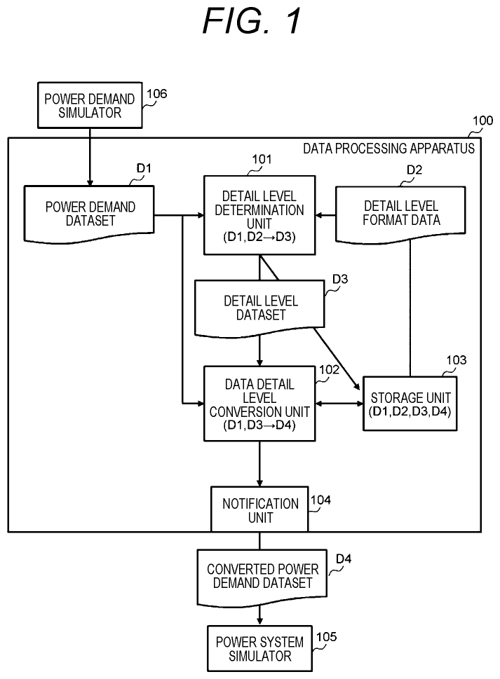

FIG. 1 is a block diagram showing a configuration of a data processing apparatus according to the embodiment.

In FIG. 1, a data processing apparatus 100 acquires power demand data generated based on a simulation related to power demand, and converts a detail level of the power demand data (also referred to as a data detail level) into a detail level necessary for coordination with the simulation. The data processing apparatus 100 is connected to a power demand simulator 106 and a power system simulator 105.

The power demand simulator 106 conducts the simulation related to power demand and outputs a power demand dataset D1. The power demand dataset D1 is a dataset related to power demand. A “dataset” is a single logical chunk of electronic data as seen by a program such as an application program, and may be, for example, any one of a record, a file, a key-value pair, and a tuple.

The power demand dataset D1 includes information on items related to power demand. Examples of items of adjustment capability used for executing a supply and demand control simulation utilizing the adjustment capability include numerical values or the like for a power consumption amount per time frame, a reducible demand amount and an increasable demand amount that are demand amounts capable of being reduced and increased at a planning stage, a changeable demand reduction amount and a changeable demand reduction amount that are demand amounts capable of being reduced and increased when there is a demand adjustment command on a current day, and an adjustable demand reduction amount and an adjustable demand increase amount that are demand amounts of which output can be reduced and increased within the time frame as appropriate when the demand adjustment command is received.

Further, examples of items of information about position necessary in the simulation of adjusting demand in order to maintain a current acceptable range in a distribution system and a specified voltage range of the distribution system include a position where the demand is connected to a power line in the distribution system, latitude and longitude information that serves as information for determining which area of substation the demand belongs to, data about which distribution line the demand is connected to, data about whether the demand is coordinated between voltage levels, and the like.

Further, for example, a time interval of each time-series data may be defined so that the shorter the interval, the higher the detail level. The time interval may be a 30-minute interval that is a current trading unit, or may be a few-minute interval for the future.

The power system simulator 105 conducts a simulation related to power supply and demand based on a converted power demand dataset D4. The converted power demand dataset D4 is a dataset obtained by converting the detail levels of the power demand dataset D1 into a detail level necessary for the simulation in the power system simulator 105. For example, when the power demand dataset D1 does not meet the detail level necessary for executing the simulation, the converted power demand dataset D4 can be obtained by redressing excess or lack of the information of that power demand dataset D1.

The data processing apparatus 100 includes a detail level determination unit 101, a data detail level conversion unit 102, a storage unit 103, and a notification unit 104.

The detail level determination unit 102 calculates a detail level dataset D3 from the power demand dataset D1 based on detail level format data D2. The detail level format data D2 is data in which a detail level format for the power demand dataset D1 is defined. The detail level format can define the detail level of the power demand data. The detail level can define a degree indicating how large an information amount of the power demand data is. A data item to be included in the power demand data can be specified for each detail level. At this time, the detail level is defined at N (N is an integer of two or more) stages, and the data item of the power demand data can be specified for each stage of that detail level.

For example, the detail level format data D2 can represent a correspondence between classifications of the detail level defined in advance based on the information amount and attributes included in the detail level, the attributes including attributes related to adjustment capability, a time interval size of the data, and discrete information such as position information, included in the power demand data. If there are multiple conditions for applying to the detail level, it is only necessary to satisfy one of them.

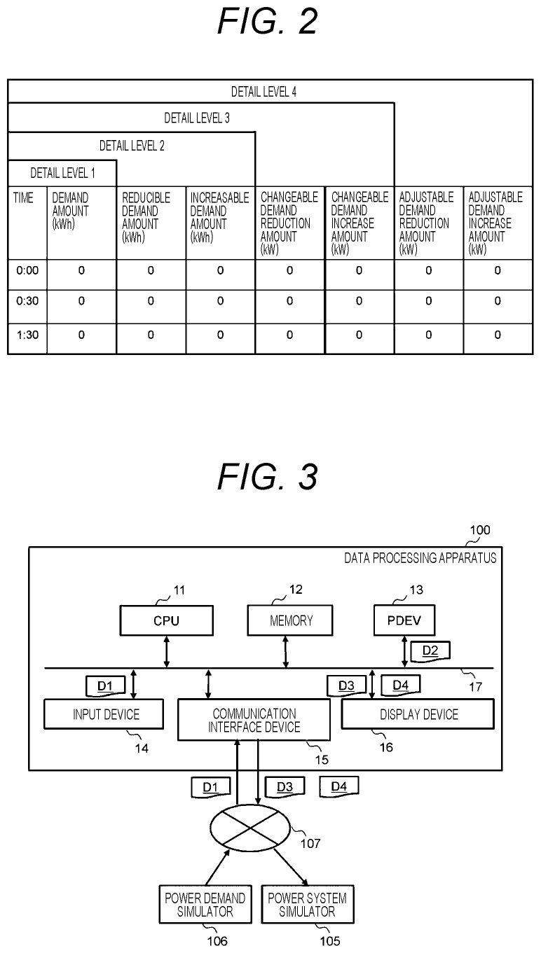

FIG. 2 is a diagram showing an example of the detail level format data of FIG. 1 FIG. 2 shows a specific example of a concept of the detail level regarding the attributes related to adjustment capability.

In FIG. 2, for each time, a case only with the demand amount as the attribute can be classified into a detail level 1, a case with one of the reducible demand amount and the increasable demand amount as the attribute can be classified into a detail level 2, a case with one of the changeable demand reduction amount and the changeable demand reduction amount can be classified into a detail level 3, and a case with one of the adjustable demand reduction amount and the adjustable demand increase amount can be classified into a detail level 4.

Note that the example of FIG. 2 shows a case where the detail level is defined at four stages in the detail level format data D2, but the detail level may be defined at N (N is an integer of two or more) stages.

Returning to FIG. 1, the detail level dataset D3 is a dataset representing a result of determining which detail level format in the detail level format data D2 the power demand dataset D1 corresponds to. The detail level dataset D3 can indicate the detail levels calculated for the data items of the power demand data used in the power system simulator 105.

The data detail level conversion unit 103 calculates the converted power demand dataset D4 based on the power demand dataset D1 and the detail level dataset D3. At this time, the data detail level conversion unit 103 calculates the converted power demand dataset D4 so as to match the detail levels of the power demand dataset D1 to the detail level required for the simulation in the power system simulator 105. For example, the data detail level conversion unit 103, if there is a lacking data item for the detail level required for the simulation in the power system simulator 105, supplements that data item and, if there is an extra data item for the detail level required for the simulation in the power system simulator 105, deletes that data item.

The storage unit 105 stores various data including input data and a program. At this time, the storage unit 105 can store the power demand dataset D1, the detail level format data D2, the detail level dataset D3, and the converted power demand dataset D4. The notification unit 104 displays a detail level conversion result indicated by the converted power demand dataset D4, and notifies the power system simulator 105 of the converted power demand dataset D4.

As described above, the data processing apparatus 100 calculates based on the detail level format data D2 the detail level that is a degree indicating how large the information amount of the power demand dataset D1 is, and converts based on that calculated detail level the power demand dataset D1 into the converted power demand dataset D4 to be output so that the detail level necessary for the coordinated simulation is achieved. Therefore, even when the detail level of data is inconsistent among a plurality of simulators, it is possible to reduce a data conversion operation for combining these simulators to numerically analyze a phenomenon of the power system, and to reduce a burden of the analysis of the power system simulator.

The data processing apparatus 100 can be applied to regional energy management including heterogeneous systems as a supply source capable of providing demand adjustment capability, for example. The heterogeneous systems include, for example, a transportation system of electric vehicles, and an air conditioner system utilizing flows of people in a subway, a building, an elevator, or the like.

Note that the data processing apparatus 100 may not have the data detail level conversion unit 103. In that case, the notification unit 104 may adopt, as a notification based on one or more data detail levels determined for respective one or more power demand data, for example, a view of a list of the multiple power demand data and the multiple data detail levels.

The data processing apparatus 100 may be configured with at least one computer. For example, when a computer has a display device and displays information on the display device, this computer may be the data processing apparatus 100. Further, for example, when a first computer (for example, a server) transmits information for display to a remote second computer (a display computer (for example, a client)) and the display computer displays that information (when the first computer displays the information on the second computer), at least the first computer among the first computer and the second computer may be the data processing apparatus 100.

“Displaying the information for display” may mean that the computer in the data processing apparatus 100 displays the information for display on the display device of the computer, or that the computer transmits the information for display to the display computer (in the latter case, the display computer displays the information for display).

The data processing apparatus 100 may have an interface device unit, a storage unit, and a processor unit connected to them. Further, the data processing apparatus 100 may be a virtual apparatus or a software-defined apparatus provided based on computer resource pools (for example, interface device units, storage units, and processor units) such as a cloud platform.

The “interface device unit” may be one or more interface devices. The one or more interface devices may be any one of the following.
An input/output (I/O) interface device for at least one of an I/O device and a remote terminal computer. An I/O interface device for the display computer may be a communication interface device. At least one I/O device may be a user interface device, for example, either an input device such as a keyboard and a pointing device, or an output device such as a display device.
One or more communication interface devices. The one or more communication interface devices may be one or more homogeneous communication interface devices (for example, one or more network interface cards (NICs)) or two or more heterogeneous communication interface devices (for example, a NIC and a host bus adapter (HBA)).

The “storage unit” may be at least a memory unit among the memory unit and a PDEV unit. The “memory unit” is one or more memories, and may typically be a main storage device. At least one memory in the memory unit may be a volatile memory or a non-volatile memory.

The “PDEV unit” is one or more PDEVs, and may typically be an auxiliary storage device. The “PDEV” means a physical storage device, and is typically a non-volatile storage device such as, for example, a hard disk drive (HDD) or a solid-state drive (SSD).

The “processor unit” is one or more processors. At least one processor is typically a microprocessor such as a central processing unit (CPU), but may be another type of processor such as a graphics processing unit (GPU). At least one processor may be single-core or multi-core. At least one processor may be a processor in a broad sense such as a hardware circuit that performs a part or all of processing (for example, a field-programmable gate array (FPGA) or an application specific integrated circuit (ASIC)).

Further, in FIG. 1, the functions have been described using expressions of “kkk unit” (excluding the interface device unit, the storage unit, and the processor unit), but may be realized by the processor unit executing one or more computer programs or may be implemented by one or more hardware circuits (for example, an FPGA or an ASIC). When realized by the processor unit executing a program, the function may be regarded as at least a part of the processor unit since a specified process is performed by appropriately using the storage unit, the interface device unit, and/or the like. A process described in such a manner that the function is main may be a process performed by the processor unit or an apparatus having that processor unit. The description of each function is an example, and a plurality of functions may be combined into one function, or one function may be divided into a plurality of functions.

FIG. 3 is a block diagram showing an example of a hardware configuration of the data processing apparatus of FIG. 1.

In FIG. 3, the data processing apparatus 100 is realized by a computer (and its peripheral apparatuses) such as, for example, a general-purpose computer or a server. The data processing apparatus 100 includes a CPU 11, a memory 12, a PDEV 13, an input device 14, a communication interface device 15, and a display device 16. The CPU 11, the memory 12, the PDEV 13, the input device 14, the communication interface device 15, and the display device 16 are connected to each other via a bus 17. The communication interface device 15 is connected to the power demand simulator 106 and the power system simulator 105 via a network 107. The network 107 may be a wide area network (WAN) such as the Internet, or a local area network (LAN) such as Wi-Fi or Ethernet (registered trademark), or a combination of a WAN and a LAN.

The CPU 11 calculates the detail levels of the power demand dataset D1 based on the detail level format data D2 by reading and executing one or more programs stored in the PDEV 13, and converts the power demand dataset D1 into the converted power demand dataset D4 to be output based on the calculated detail levels so that the detail level necessary for the coordinated simulation is achieved. At this time, the CPU 11 can realize the functions of the detail level determination unit 101, the data detail level conversion unit 102, and the notification unit 104 in FIG. 1. Instead of the CPU 11, an arithmetic processing unit configured with one or more semiconductor chips may be used. The program executed by the CPU 11 may be installed from a program source or may be incorporated in the data processing apparatus 100 as firmware. The program source may be, for example, a program distribution computer or a computer-readable recording medium (for example, a non-temporary recording medium).

The memory 12 is, for example, a random-access memory (RAM), and temporarily stores the program read from the PDEV 13, a dataset of an operation process by the CPU 11, and the like.

The PDEV 13 is, for example, an HDD or an SSD, and stores the program executed by the CPU 11, various datasets for the data processing apparatus 100 (for example, the detail level format data D2, the detail level dataset D3, and the converted power demand dataset D4), and the like.

The input device 14 is, for example, at least any one of a keyboard switch, a pointing device such as a mouse, a touch panel, a voice command device, and a non-contact input apparatus by detecting eye movement and blinking, and inputs a dataset (for example, the power demand dataset D1) to the data processing apparatus 100 in response to an operation by a user.

At this time, the data processing apparatus 100 can acquire via the input device 14 the power demand dataset D1 including the power demand information calculated through the simulation. For example, a value corresponding to at least one power demand data item is input, and the power demand dataset D1 including the power demand data corresponding to the at least one power demand data item is regularly or irregularly input to the data processing apparatus 100.

The communication interface device 15 is hardware having a function of controlling communication with the outside. The communication interface device 15 is connected to the power demand simulator 106 and the power system simulator 105 via the network 107. The communication interface device 15 can receive the power demand dataset D1 from the power demand simulator 106, and transmit the detail level dataset D3 and the converted power demand dataset D4 to the power system simulator 105.

The display device 16 is, for example, a display or a printer, and displays a screen or the like for user operation of the data processing apparatus 100, and displays the detail level dataset D3 and the converted power demand dataset D4.

Note that the CPU 11 is an example of the processor unit. The memory 12 and the PDEV 13 are examples of the storage unit. The communication interface device 15 is an example of the interface device unit.

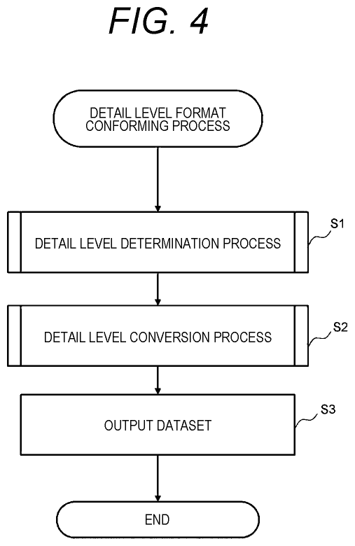

FIG. 4 is a flowchart showing a detail level format conforming process of the data processing apparatus of FIG. 1.

In S1 of FIG. 4, the detail level determination unit 101 of FIG. 1 performs a detail level determination process on the power demand dataset D1 based on the detail level format data D2. This generates the detail level dataset D3.

Next, in S2, the data detail level conversion unit 102 performs a detail level conversion process on the power demand dataset D1 based on the detail level dataset D3. This generates the converted power demand dataset D4.

Next, in S3, the notification unit 104 displays a result of the conversion of the power demand data indicated by the converted power demand dataset D4.

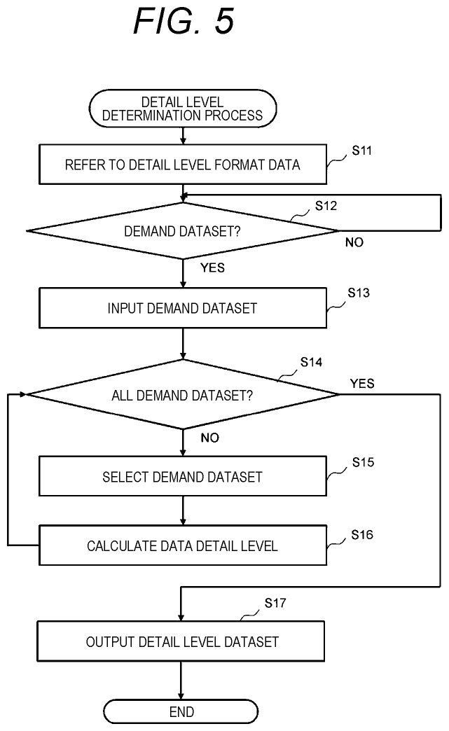

FIG. 5 is a flowchart showing the detail level determination process of FIG. 4.

In S11 of FIG. 5, the detail level determination unit 102 reads the detail level format data D2 from the storage unit 103 and refers to the detail level format data D2.

Next, in S12, the detail level determination unit 102 determines whether or not the power demand dataset D1 has already been obtained. If the power demand dataset D1 has not already been obtained, the determination of S12 is repeatedly performed until the power demand dataset D1 is obtained. When the power demand dataset D1 is obtained, the detail level determination unit 102 proceeds to S13.

Next, in S13, the detail level determination unit 102 reads the power demand dataset D1 from, for example, the PDEV 13 of FIG. 3 into the memory 12.

Next, in S14, the detail level determination unit 102 determines whether or not the data detail levels for all the power demand data have been calculated. If the data detail levels for all the power demand data have not been calculated, the detail level determination unit 102 proceeds to S15.

Next, in S15, the detail level determination unit 102 selects any of the power demand data for which the data detail level has not been calculated.

Next, in S16, the detail level determination unit 102 calculates the data detail level for the power demand data selected in S15 based on a result of the reference to the detail level format data D2. The detail level determination unit 102 repeatedly performs the processing from S14 to S16 until the data detail levels for all the power demand data have been calculated. When the data detail levels for all the power demand data have been calculated, the detail level determination unit 102 proceeds to S17.

Next, in S17, the detail level determination unit 102 creates the detail level dataset D3 indicating the data detail levels of the respective power demand data, and outputs the detail level dataset D3. At this time, the detail level determination unit 102 can store the detail level dataset D3 in the storage unit 103 and output it to the notification unit 104. Note that the notification unit 104 may display the detail level dataset D3 on the display device 16 of FIG. 3 or the like.

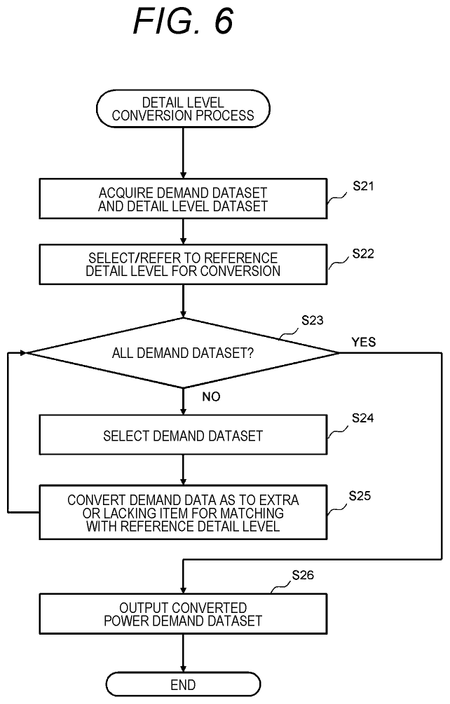

FIG. 6 is a flowchart showing the detail level conversion process of FIG. 4.

In S21 of FIG. 6, the data detail level conversion unit 103 of FIG. 1 acquires the power demand dataset D1 and the detail level dataset D3. At this time, the data detail level conversion unit 103 may acquire the power demand dataset D1 from the storage unit 103 or from the power demand simulator 106. Further, the data detail level conversion unit 103 may acquire the detail level dataset D3 from the storage unit 103 or from the detail level determination unit 102.

Next, in S22, the data detail level conversion unit 103 selects a reference detail level as a reference to which the detail levels are matched. As a method for this selection, for example, the detail level necessary for the simulation to be conducted by the power system simulator may be acquired from the storage unit 103, or may be specified by a numerical value input from an input unit.

Next, in S23, the data detail level conversion unit 103 determines whether or not data detail level matching processing has been conducted for all the power demand data. If the data detail level matching processing has not been conducted for all the power demand data, the data detail level conversion unit 103 proceeds to S24.

Next, in S24, the data detail level conversion unit 103 selects any of the power demand data of which detail level has not been converted.

Next, in S25, the data detail level conversion unit 103 converts the detail level of the power demand data so that a plurality of detail levels indicated by the detail level dataset D3 match the reference detail level. As a method for converting the detail level, for example, when a detail level among a plurality of detail levels is increased, a method of supplementation using a representative value of statistical data can be adopted. Further, for example, when the detail level is decreased, a method of deleting unnecessary data can be adopted. As criteria for the supplementation, a demand type (demand for electric vehicles in an area, a shopping mall, etc.) and scale information (for example, the number of electric vehicles in the demand for electric vehicles in the area, information on an establishment in a real property registry of the shopping mall (total floor area, etc.)) may be input, and thus a corresponding predetermined representative value may be selected. In the conversion processing, a representative value calculated based on past data may be inserted when there is no input, or conversion method options may be displayed on a display unit to be specified through the input unit using a pull-down list or the like.

The data detail level conversion unit 103 repeatedly performs the processing from S23 to S25 until the detail levels of all the power demand data have been converted so as to match the reference detail level. When the detail levels of all the power demand data have been converted so as to match the reference detail level, the data detail level conversion unit 103 proceeds to S26.

Next, in S26, the data detail level conversion unit 103 outputs the converted power demand dataset D4. At this time, the data detail level conversion unit 103 can store the converted power demand dataset D4 in the storage unit 103 and output it to the notification unit 104. Note that the notification unit 104 may display the converted power demand dataset D4 on the display device 16 of FIG. 3 or the like.

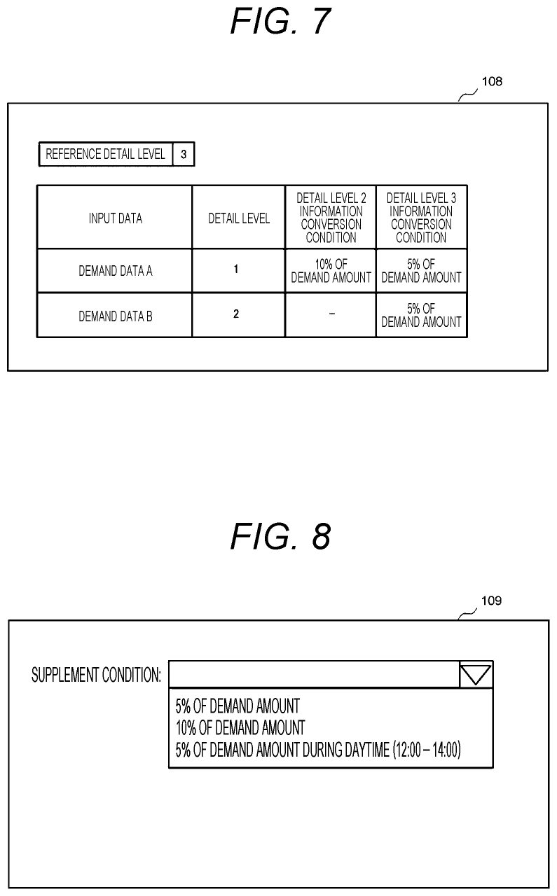

FIG. 7 is a diagram showing a display example of conversion conditions for the detail level dataset of FIG. 1.

In FIG. 7, power demand data A is assumed to include only the demand amount as the data item. At this time, the detail level determination unit 101 of FIG. 1 refers to the detail level format data D2 of FIG. 2, and compares the data items included in the detail levels 1 to 4 in the detail level format data D2 of FIG. 2 with the data item of the power demand data A. Then, the detail level determination unit 101 selects the detail level having the data item that matches the data item of the power demand data A from the detail level format data D2. Since the detail level including only the demand amount as the data item is defined as 1 in the detail level format data D2, the detail level determination unit 101 determines that the detail level of the power demand data A is 1.

Further, the power demand data B is assumed to include only the demand amount, the reducible demand amount, and the increasable demand amount as the data items. At this time, the detail level determination unit 101 refers to the detail level format data D2 of FIG. 2, and compares the data items included in the detail levels 1 to 4 in the detail level format data D2 of FIG. 2 with the data items of the power demand data B. Then, the detail level determination unit 101 selects the detail level having the data items that match the data items of the power demand data B from the detail level format data D2. Since the detail level including only the demand amount, the reducible demand amount, and the increasable demand amount as the data items is defined as 2 in the detail level format data D2, the detail level determination unit 101 determines that the detail level of the power demand data B is 2.

At this time, the detail level determination unit 101 can create the detail level dataset D3 with detail level data of the detail level 1 for the power demand data A and detail level data of the detail level 2 for the power demand data B.

Next, the data detail level conversion unit 103 is assumed to have selected 3 as the reference detail level. At this time, the data detail level conversion unit 103 converts the detail level of the power demand data A from 1 to 3, and converts the detail level of the power demand data B from 2 to 3.

In order to convert the detail level of the power demand data A from 1 to 3, the data detail level conversion unit 103 supplements data items lacking in the power demand data A so that it has the data items for the detail level 3. As shown in the detail level format data D2 of FIG. 2, the detail level 3 includes as the data items the reducible demand amount, the increasable demand amount, the changeable demand reduction amount, and the changeable demand reduction amount, as well as the demand amount. Thus, the data detail level conversion unit 103 supplements the data items of the reducible demand amount, the increasable demand amount, the changeable demand reduction amount, and the changeable demand reduction amount to the power demand data A.

The data detail level conversion unit 103 can refer to a detail level 2 information conversion condition in order to supplement the data items of the reducible demand amount and the increasable demand amount to the power demand data A. Assuming that a condition of 10% of demand amount is set as the detail level 2 information conversion condition, for example, the data detail level conversion unit 103 can set 10% of the demand amount to the reducible demand amount and the increasable demand amount.

The data detail level conversion unit 103 can refer to a detail level 3 information conversion condition in order to supplement the data items of the changeable demand reduction amount and the changeable demand reduction amount to the power demand data A. Assuming that a condition of 5% of demand amount is set as the detail level 3 information conversion condition, for example, the data detail level conversion unit 103 can set 5% of the demand amount to the changeable demand reduction amount and the changeable demand reduction amount.

In order to convert the detail level of the power demand data B from 2 to 3, the data detail level conversion unit 103 supplements data items lacking in the power demand data B so that it has the data items for the detail level 3. As shown in the detail level format data D2 of FIG. 2, the detail level 3 includes as the data items the changeable demand reduction amount and the changeable demand reduction amount, as well as the demand amount, the reducible demand amount, and the increasable demand amount. Thus, the data detail level conversion unit 103 supplements the data items of the changeable demand reduction amount and the changeable demand reduction amount to the power demand data B.

The data detail level conversion unit 103 can refer to the detail level 3 information conversion condition in order to supplement the data items of the changeable demand reduction amount and the changeable demand reduction amount to the power demand data B. Assuming that a condition of 5% of demand amount is set as the detail level 3 information conversion condition, for example, the data detail level conversion unit 103 can set 5% of the demand amount to the changeable demand reduction amount and the changeable demand reduction amount.

At this time, as shown in FIG. 7, a display screen 108 of the display device 16 of FIG. 3 displays the conversion conditions for the detail level dataset D3 when the reference detail level is 3.

Note that the detail level 2 information conversion condition and the detail level 3 information conversion condition for the power demand data A can be given by conditional expressions capable of being calculated from the power demand data A. Further, the detail level 3 information conversion condition for the power demand data B can be given by a conditional expression capable of being calculated from the power demand data B. As a result, the data detail level conversion unit 103 can supplement the data items lacking in the power demand data A based on the information of the power demand data A, and the data items lacking in the power demand data B based on the information of the power demand data B.

FIG. 8 is a diagram showing an example of an input screen for detail level supplement conditions displayed on the display device of FIG. 3.

In FIG. 8, the display device 16 of FIG. 3 displays a display screen 109 for setting the detail level 2 information conversion condition and the detail level 3 information conversion condition of FIG. 7. The display screen 109 displays the interpolation conditions in a pull-down list for setting the detail level 2 information conversion condition and the detail level 3 information conversion condition. Then, an operator can set the detail level 2 information conversion condition and the detail level 3 information conversion condition of FIG. 7 by selecting the interpolation condition from the pull-down list displayed on the display screen 109.

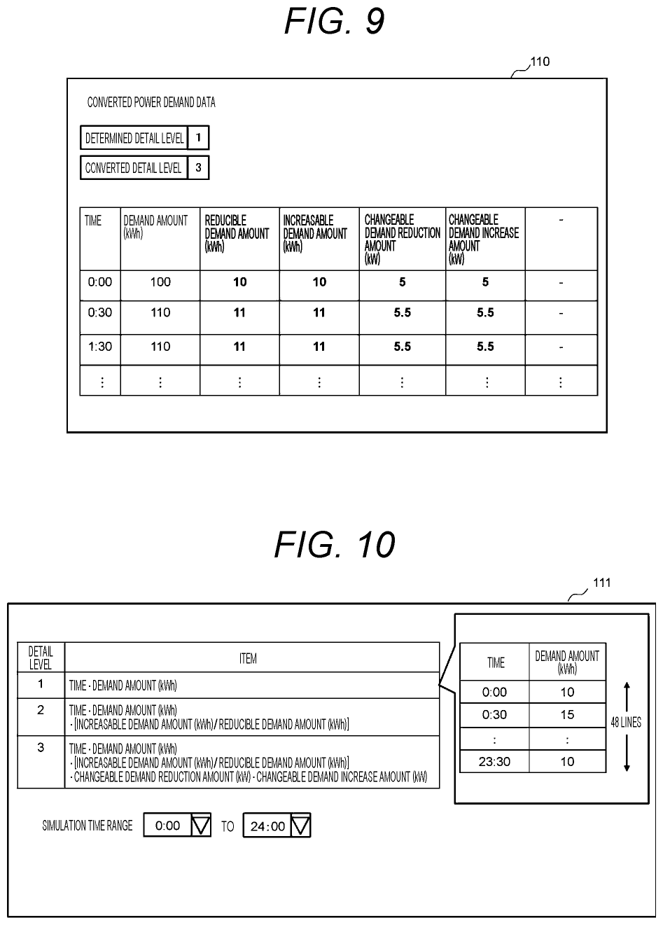

FIG. 9 is a diagram showing an example of a display screen for the converted power demand data displayed on the display device of FIG. 3. Note that, the example of FIG. 9 shows the converted power demand data with respect to the power demand data A of FIG. 7.

In FIG. 9, a display screen 110 of the display device 16 of FIG. 3 displays a data conversion result indicated by the converted power demand dataset D4.

Here, the data detail level conversion unit 103 of FIG. 1 refers to the detail level 2 information conversion condition and the detail level 3 information conversion condition for the power demand data A of FIG. 7. Here, since the detail level 2 information conversion condition is 10% of demand amount, the data detail level conversion unit 103 calculates a value of 10% of the demand amount and sets it to the reducible demand amount and the increasable demand amount for each time. Further, since the detail level 3 information conversion condition is 5% of demand amount, the data detail level conversion unit 103 calculates a value of 5% of the demand amount and sets it to the changeable demand reduction amount and the changeable demand increase amount for each time.

As a result, it is possible to convey to the operator that the power demand data can be used for a power system analysis. In a display method, the detail level determined by the detail level determination unit 102 and the converted detail level are displayed side by side, and information added to the power demand dataset D1 through the conversion processing is highlighted in bold or color, which can result in more effectively conveying the process to the operator.

Note that the display screen 110 may further display, in addition to the conversion result, additional information necessary for improving the detail level, its expected effects (a model showing usable demand adjustment capability and its accuracy, a possible simulation type, and reliability of analysis information), and the like. This can support determination by the operator.

As described above, the above-described data processing apparatus 100 allows a dataset to be exchanged between the power demand simulator 106 and the power system simulator 105 by calculating based on the detail level format data D2 the data detail level that is a degree indicating how large the information amount of the power demand data is and converting the power demand data based on the calculated data detail level so that the detail level necessary for the coordinated simulation is achieved, which can reduce a burden of integrated analysis related to power energy management.

FIG. 10 is a diagram showing an example of a display screen for a detail level input format displayed on the display device of FIG. 3.

In FIG. 10, a display screen 111 displays items corresponding to each detail level. Further, regarding a table of the detail levels on the display screen 111, a data format may be popped up when the item is selected by hovering the mouse pointer over it or from the touch panel. In addition, when the input format screen is displayed, time displayed in the pop-up data may be changed or the number of lines of the data may be displayed according to a selected time range of the simulation.

This allows for assisting in creation of the power demand dataset D1 by hand or using the power demand simulator 106, and for simplifying the data coordination operation of the power demand data.

Note that mounting the data processing apparatus 100 of the present embodiment on a cloud server that provides a cloud service allows for providing a power system analysis assistance service by the cloud service. In such a power system analysis assistance service, a data manager who owns the cloud server provides system analysis data generated by a power system analysis process that uses the converted power demand dataset D4 via the cloud network to a demand control operator who formulates an operational plan for demand control using the power system analysis. Then, the demand control operator can implement the operational plan based on the provided system analysis data. According to such a power system analysis assistance service, the system analysis data can be provided to more diverse destinations.

In this cloud service, inputting, along with the power demand dataset D1, whether or not the power demand data can be diverted allows for storing divertible power demand data in the storage unit according to the detail level, and thus for collecting and recording more and a wider variety of simulation data of the power demand data. According to such a cloud service, more power demand data can be collected and organized, and the system analysis data can be provided to more diverse destinations.

In addition, conversion criteria used for the detail level matching may be updated based on the collected power demand data. For example, an optional numerical value of the reducible demand amount may be updated by averaging a ratio of the reducible demand amount to the demand amount for the collected power demand data. This allows for supplementing the power demand data based on a wider variety of data in converting the detail level, and thus for providing the power demand data suitable for a more specific simulation.

The embodiment of the present invention has been described above. However, the embodiment is an example for explaining the present invention, and the scope of the present invention is not intended to be limited to the embodiment. The present invention can also be implemented in various other forms.

For example, in the above-described embodiment, the method of converting the detail level of the power demand data input to the data processing apparatus 100 into the detail level required at the output destination has been described. However, in addition to the power demand data, a detail level of various other input data such as control data or monitoring data may be converted into a detail level required at an output destination so as to be conformed to the detail level required at the output destination.

Further, in the above-described embodiment, a case where the power demand data is simulation data has been taken as an example, but the power demand data may be actual measurement data. Further, in the above-described embodiment, the method of converting the detail level of the power demand data for realizing a coordinated simulation has been described. However, in order to realize a coordinated process other than the simulation, a detail level of data used in that process may be converted.

### REFERENCE SIGNS LIST

100 data processing apparatus
101 detail level determination unit
102 data detail level conversion unit
103 storage unit
D1 power demand dataset
D2 detail level format data
D3 detail level dataset
D4 converted power demand dataset

1. A data processing apparatus comprising:
a detail level determination unit configured to determine a detail level of power demand data based on a detail level format in which a detail level is defined based on a degree indicating how large an information amount of the power demand data is; and
a detail level conversion unit configured to match the detail level of the power demand data determined by the determination unit to a required detail level of the power demand data.

2. The data processing apparatus according to claim 1, wherein the detail level format represents a correspondence between a classification of the detail level defined based on the information amount and an attribute included in the detail level under the classification.

3. The data processing apparatus according to claim 1, wherein the detail level conversion unit is configured to match the detail level of the power demand data determined by the determination unit to a detail level required for a simulation that uses the power demand data.

4. The data processing apparatus according to claim 3, wherein
when the detail level of the power demand data determined by the determination unit does not match the required detail level of the power demand data,
the detail level conversion unit is configured to supplement a data item lacking for the required detail level of the power demand data and delete an extra data item.

5. The data processing apparatus according to claim 4, wherein the detail level conversion unit is configured to supplement the data item based on a conversion condition for the detail level insufficient for the required detail level of the power demand data.

6. The data processing apparatus according to claim 1, wherein the detail level in the detail level format is defined at N stages, N being an integer of two or more, and a data item of the power demand data is specified for each stage of the detail level.

7. The data processing apparatus according to claim 6, wherein
a demand amount is specified as the data item for the detail level at a first stage,
a reducible demand amount and an increasable demand amount, in addition to the data item for the first stage, are specified as the data items for the detail level at a second stage,
a changeable demand reduction amount and a changeable demand increase amount, in addition to the data items for the second stage, are specified as the data items for the detail level at a third stage, and
an adjustable demand reduction amount and an adjustable demand increase amount, in addition to the data items for the third stage, are specified as the data items for the detail level at a fourth stage.

8. A data processing system comprising:
a power demand simulator configured to conduct a simulation related to power demand and to output power demand data;
a power system simulator configured to conduct a simulation related to power supply and demand based on the power demand data output from the power demand simulator; and
a data processing apparatus configured to conduct a conversion process on the power demand data,
the data processing apparatus including:
a detail level determination unit configured to determine a detail level of the power demand data output from the power demand simulator based on a detail level format in which a detail level is defined based on a degree indicating how large an information amount of the power demand data is; and
a detail level conversion unit configured to match the detail level of the power demand data determined by the determination unit to a detail level of the power demand data required by the power system simulator.

9. A data processing method executed by a processor, comprising:
by the processor,
determining a detail level of input data based on a detail level format in which a detail level is defined based on a degree indicating how large an information amount of the input data is; and
conforming the determined detail level of the input data to a detail level required at an output destination.

10. The data processing method according to claim 9, comprising:
by the processor,
acquiring the input data generated based on a simulation; and
converting the detail level of the input data into a detail level necessary for coordination with the simulation.
